(19) United States
(12) Patent Application Publication
(10) Pub. No.: US 2023/0225558 A1
(43) Pub. Date: Jul. 20, 2023

(54) Grill

(71) Applicant: Lawrence James Klecker, JR., Centerville, MN (US)

(72) Inventor: Lawrence James Klecker, JR., Centerville, MN (US)

(21) Appl. No.: 17/578,511

(22) Filed: Jan. 19, 2022

(51) Int. Cl. A47J 37/07

(52) U.S. Cl. CPC A47J 37/079; A47J 37/0704

(57) ABSTRACT

The inventive grill uses slide coal technology, which allows coal to be put into a hopper, positioned to one side of the grill, and then has a slide chute connected to the hopper which uses gravity to slide the coal, at an angle down to a burn box which is positioned directly below the grill body. Heat obviously rises and having the burn box offset from the hopper is going to use less coal. It will use less coal both when in operation and also once it's been turned off (closing both dampers). The reason it uses less coal is because the slide and hopper are not vertically above the burn box and thus receive less heat.

### CROSS-REFERENCE TO RELATED APPLICATIONS

None.

### STATEMENT REGARDING FEDERALLY SPONSORED RESEARCH

Not Applicable

### FIELD OF THE INVENTION

The invention relates to a grill which has a slide to slide coal into a burn box which is positioned directly below the grill.

### BACKGROUND OF THE INVENTION

Prior art grills, such as the one shown at FIG. 15 have a vertical hopper and burn box which burns the coal off to the side of the grill and then blows heated air into the grill body from the side. This prior art arrangement uses more coal than necessary, as it will burn coal when in operation and when turned off, because of the vertical nature of the hopper and burn box.

What is needed is an arrangement which positions the burn box directly beneath the grill.

### BRIEF SUMMARY OF THE INVENTION

The inventive grill uses slide coal technology, which allows coal to be put into a hopper, positioned to one side of the grill, and then has a slide chute connected to the hopper which uses gravity to slide the coal, at an angle down to a burn box which is positioned directly below the grill body. Heat obviously rises and having the burn box offset from the hopper and directly below the grill body is going to use less coal and provide more direct heat into the grill. It uses less coal both when in operation and also once it's been turned off. The reason it uses less coal is because the slide and hopper are not vertically above the burn box and thus more heat is directed into the grill, as compared to the prior art vertically stacked hopper/burn box.

The inventive grill also includes a damper positioned between the top of the burn box and the bottom of the grill body which has the ability to open and close off DIRECT heat to the grill. You can even partially close the damper so you can keep a portion of the grill hot and the other portion warm.

The inventive grill includes a grill body, the grill body having an opening in a bottom portion of the grill body; a burn box located directly below the grill body, the burn box having an open top and positioned under the opening in the bottom portion of the grill body, and a slide positioned to a side of the burn box and attached to the burn box for receiving burnable material which will be fed into the burn box by our slide coal technology.

The grill further includes an ash bin positioned below the burn box and has a fan attached to a side of the ash bin which is operated by a controller which turns the fan on or off and controls the speed of the fan. The grill also includes an electric igniter which is positioned in the burn box so that when the electric igniter is heated the burnable material will ignite and produce heat which will rise through the opening in the grill body. The grill can burn any burnable material, but commonly burns charcoal.

The grill also has a large damper which is positioned on top of the burn box and which can be slid to partially or fully block the opening in the bottom of the grill body. The grill further has a second smaller damper which is positioned between the fan and the side of the ash bin and which can be slid to partially or fully block an opening through which the fan directs air into the ash bin, which then is directed upwardly to direct air through the burn box and upwardly into the grill body. The hopper and slide are sealed so the heated air can only go up into the grill body. Not up the slide and into the hopper.

The grill further includes a support table which is attached to the base of the grill and a junction box which can be plugged into a source of electrical power to provide power to a fan and a controller.

### BRIEF DESCRIPTION OF THE DRAWINGS

FIG. 1 is a front view of the inventive grill with a cross-sectional view of the hopper, and slide and showing the burn box.

FIG. 2 shows the slide of FIG. 1.

FIG. 3 shows the hopper of FIG. 1.

FIG. 4 shows the ash bin of FIG. 1.

FIG. 5 shows the lower grill in silhouette showing the opening in the lower grill and the large damper.

FIG. 6 shows a side view of the inventive grill and shows the lower damper

FIG. 7 shows the igniter of FIG. 1.

FIG. 8 shows the fan of FIG. 1.

FIG. 9 is a front view of the inventive grill.

FIG. 10 is rear view of the inventive grill.

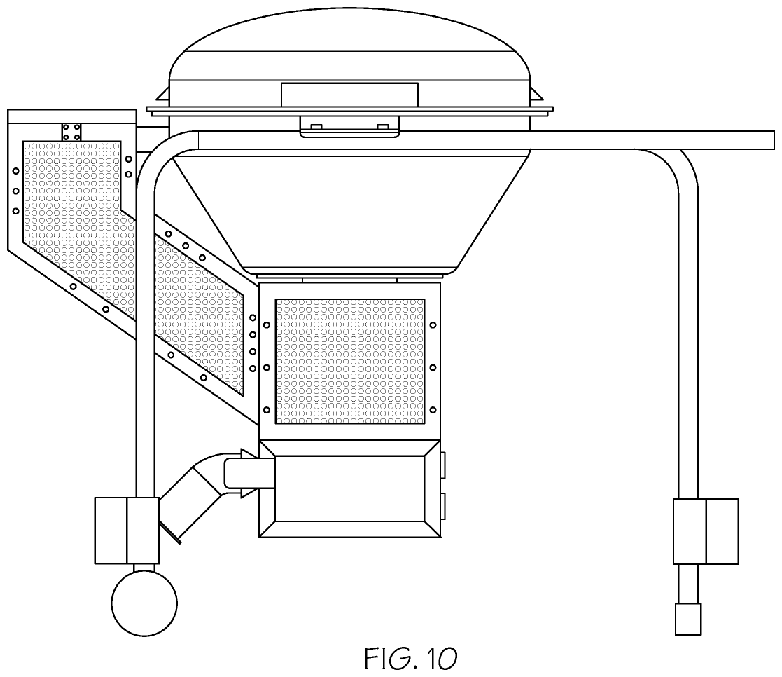

FIG. 11 is perspective view of the inventive grill with the lower grill shown in silhouette.

FIG. 12 shows a controller for the inventive grill.

FIG. 13 shows a perspective view of the controller for the inventive grill.

FIG. 14 shows a junction box which be connected to AC power to provide power for the igniter, fan and controller.

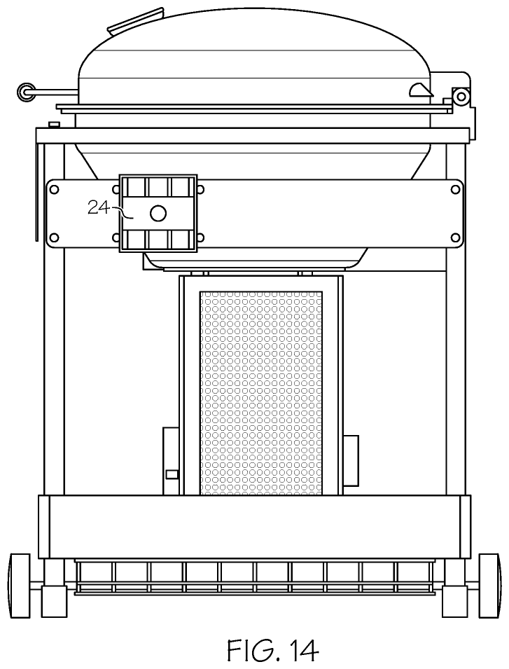

FIG. 15 shows a prior art grill.

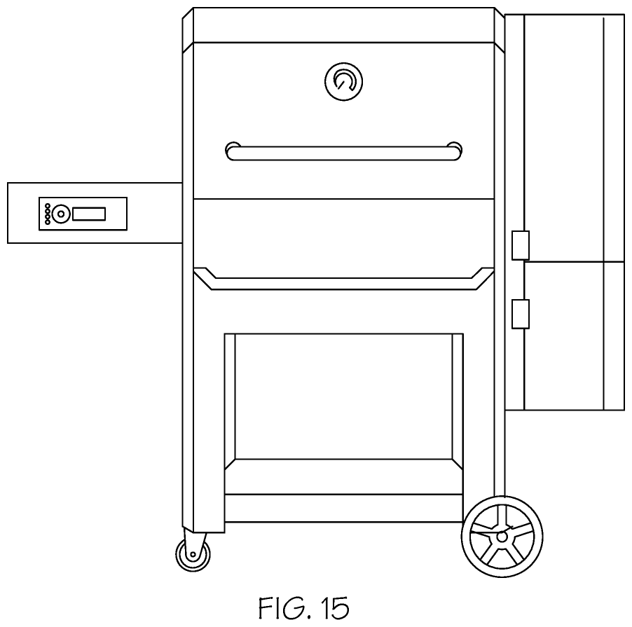

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

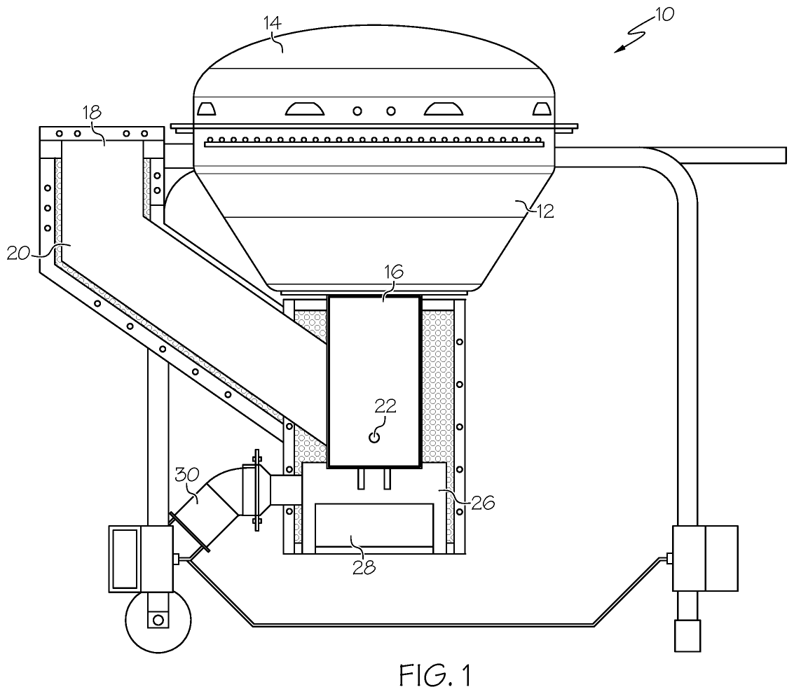

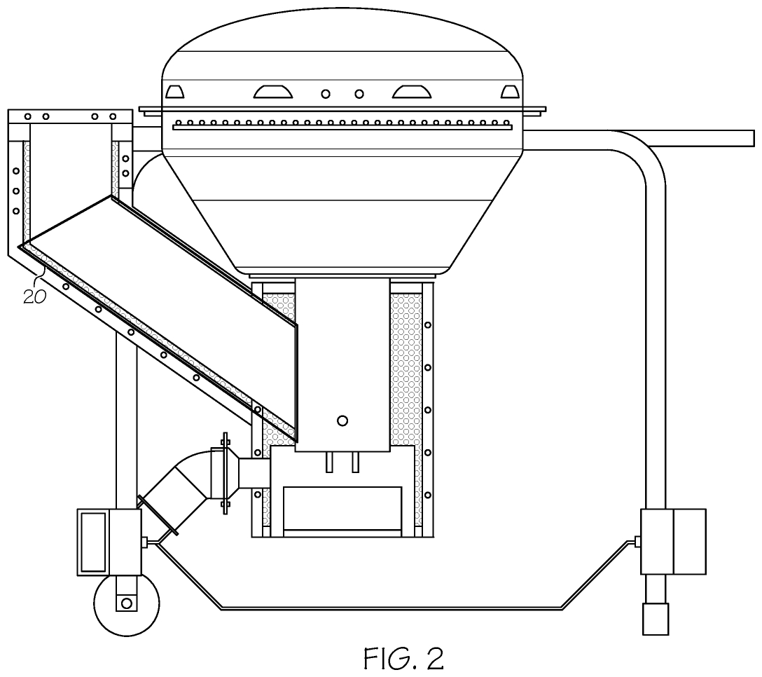

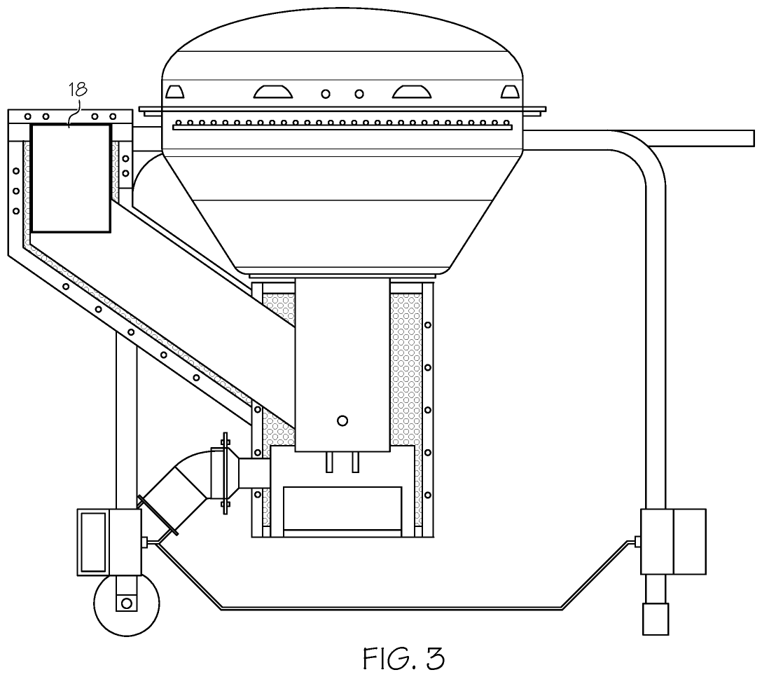

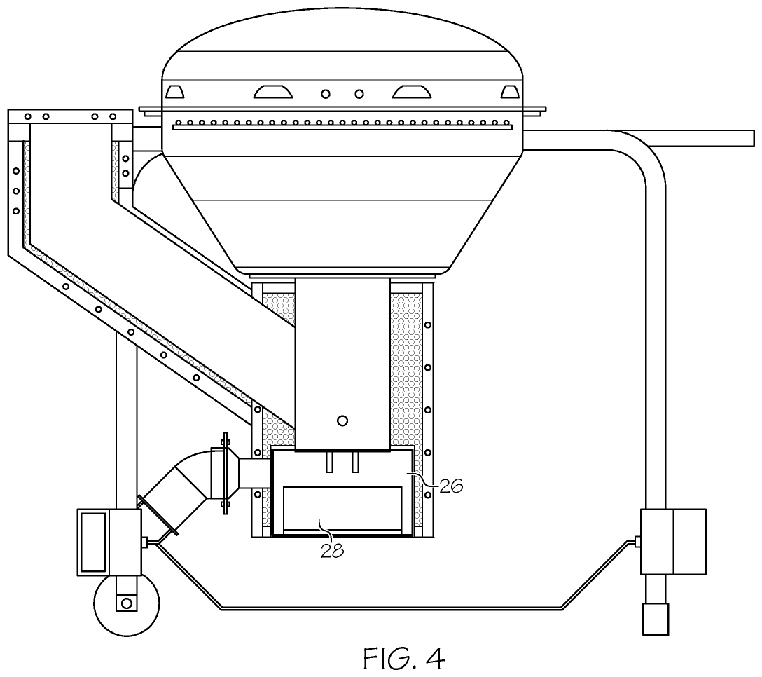

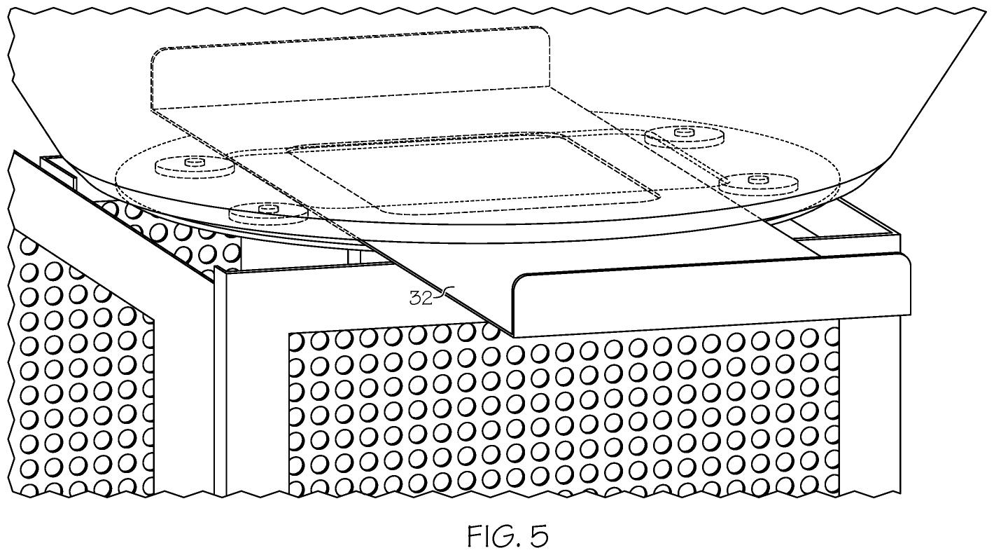

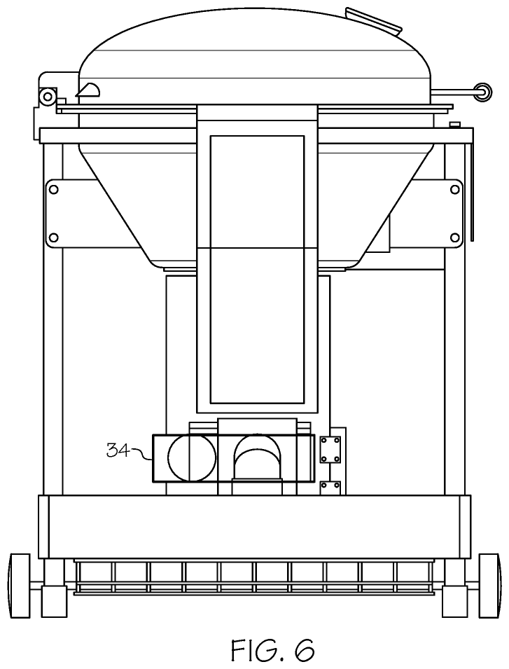

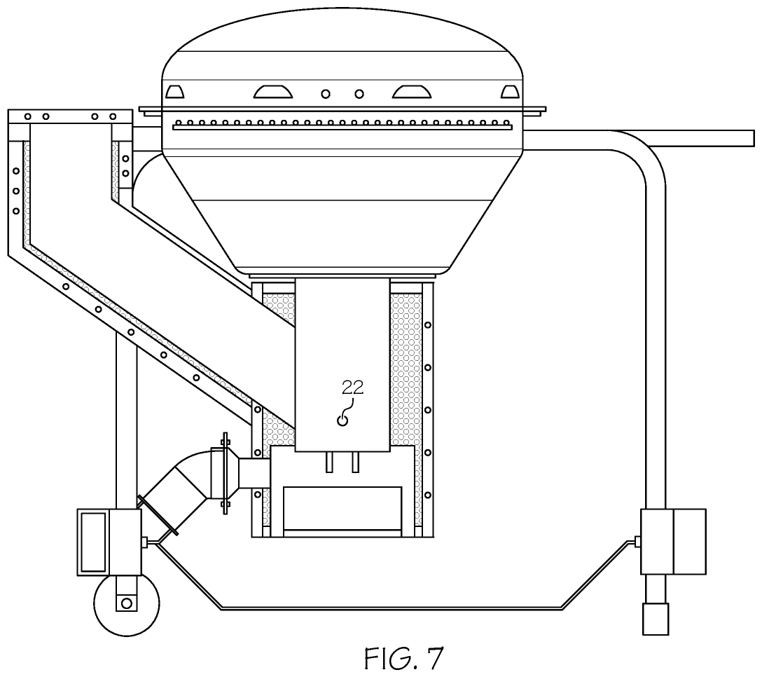

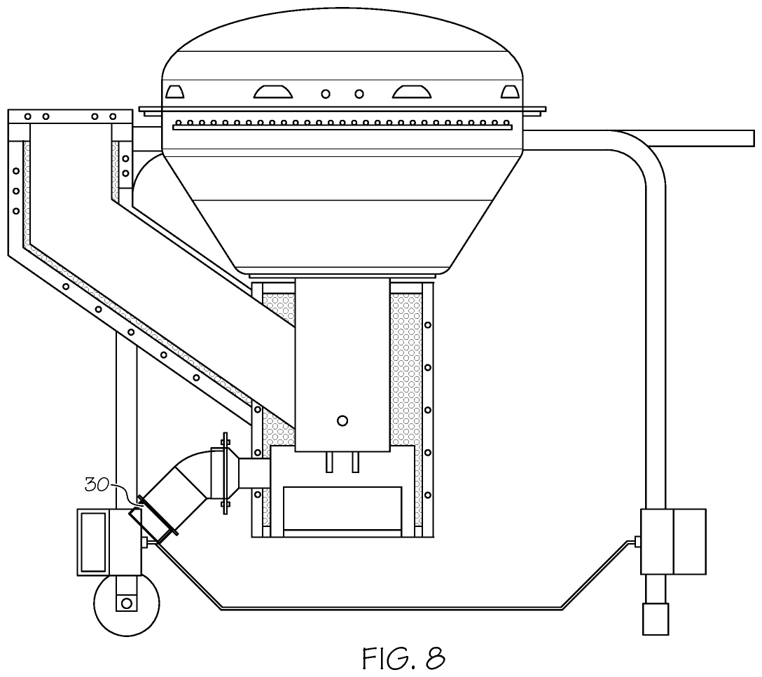

Referring now to FIGS. 1-8, the inventive grill is shown generally at 10. The grill has a lower portion 12 and a lid portion 14. A burn box 16 is positioned directly below the grill. Burnable material, preferably charcoal, is added to the hopper 18 and slides down slide 20 to enter the burn box. An igniter 22 is positioned in the burn box so that when powered, it heats up and ignites the charcoal. The igniter 22 is powered via the junction box 24, which is plugged into standard power to provide power to the igniter. An ash bin 26 is positioned below the burn box to catch the ashes and the ashes can be cleaned out via door 28. A fan is shown at 30, which is also powered via junction box 24. FIG. 5 shows the lower grill with parts cut-away to show the large damper 32. Large damper 32 has an opening which aligns with an opening in the bottom of the grill, and which allows all the heat from the burn box to rise into the grill. The large damper 32 can be pushed in to partially or totally block the opening. FIG. 6 shows a side view of the grill and shows a smaller lower damper 34, shown in the closed position. When the damper 34 is pushed to the right to align the opening with the fan opening into the ash catcher, the damper 34 is in the fully open position.

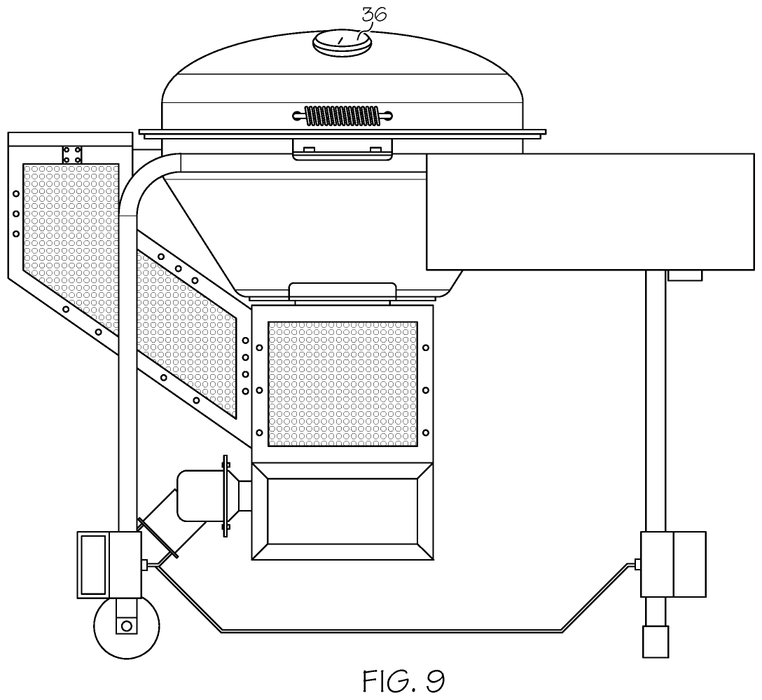

Referring now to FIG. 9, a temperature indicator is shown at 36.

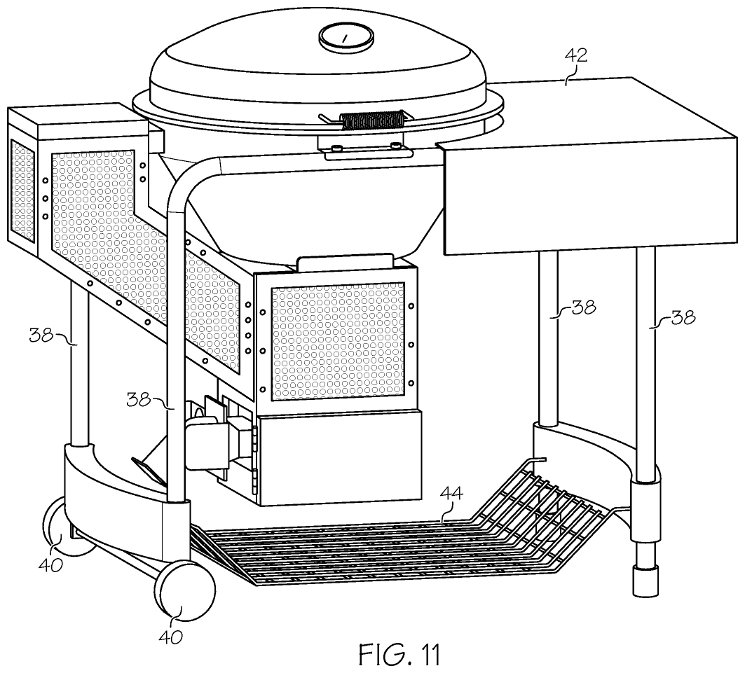

Referring now to FIG. 11, legs 38 are shown, with two of legs 38 having wheels for ease of movement of the grill. A table surface is also provided at 42. A basket is also provided at 44.

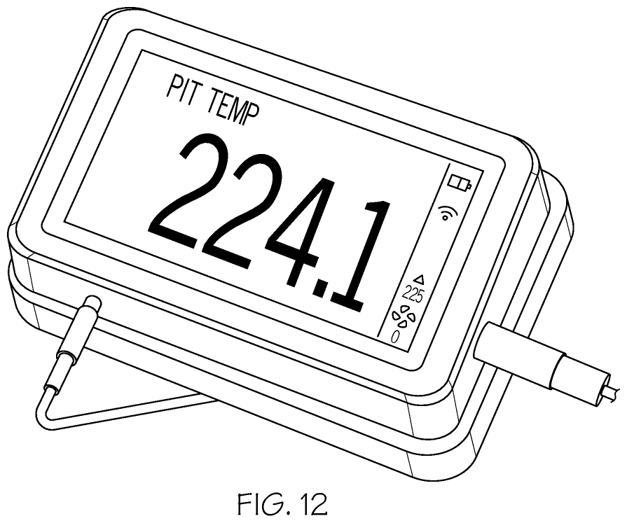

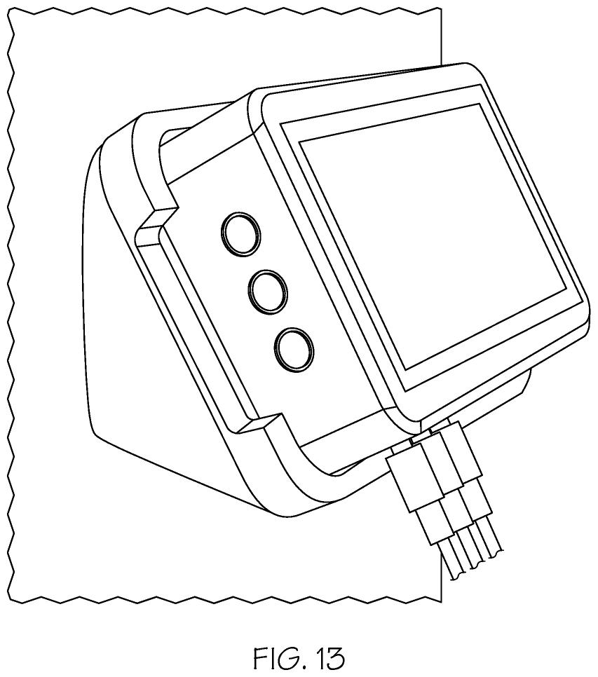

Referring now to FIGS. 12 and 13, a BBQ temperature controller is shown at 46. Any commercially available BBQ temperature controller can be used. A temperature sensor is shown at 48, which is placed inside the grill to monitor the temperature of the inside of the grill. Multiple temperature probes are supported. A power cord is shown at 50, the other end plugging into the junction box 24. The temperature controller operates with the fan 30 to bring the grill up to a temperature set point, and then maintain the temperature in the grill at the set point, as is well known in the art.

What is claimed is:

1. A grill comprising:
a grill body, the grill body having an opening in a bottom portion of the grill body;
a burn box located directly below the grill body, the burn box having an open top end positioned under the opening in the bottom portion of the grill body;
a slide positioned to a side of the grill body and attached to the burn box for receiving burnable material which will be fed into the burn box by a slide.

2. The grill of claim 1 further including an ash bin positioned below the burn box.

3. The grill of claim 2 further including a fan attached to a side of the ash bin which operated by a controller which turns the fan on or off and controls the speed of the fan.

4. The grill of claim 1 further including an electric igniter which is positioned in the burn box so that when the electric starter is heated the burnable material will ignite and produce heat which will rise through the opening in the grill body.

5. The grill of claim 1 wherein the burnable material is charcoal.

6. The grill of claim 1 further including a large damper which is positioned on top of the burn box and which can be slid to partially or fully block the opening in the bottom of the grill body.

7. The grill of claim 6 further including a lower damper which is positioned between the fan and the side of the ash catcher and which can be slid to partially or fully block an opening through which the fan directs air into the ash catcher, which then is directed upwardly to direct air through the burn box and upwardly into the grill body, and when closed at the same time as the large damper, any remaining coal will slowly cool and can be used again.

8. The grill of claim 1 further including a support table to which the grill frame is attached.

9. The grill of claim 1 further including a junction box which can be plugged into a source of electrical power to provide power to a fan and a controller.
